(19) United States
(12) Patent Application Publication
(10) Pub. No.: US 2011/0036199 A1
(43) Pub. Date: Feb. 17, 2011

(54) ANTI-VIBRATION DEVICE OF INPUT/OUTPUT SHAFT FOR MANUAL TRANSMISSION OF VEHICLE

(76) Inventors: Seung Beom RYU, Seoul (KR); Mike SUH, Jr., Torrance, CA (US)

Correspondence Address: Jae Y. Park, Kile, Park, Goekjian, Reed & McManus, PLLC, 1200 New Hampshire Ave. NW, Suite 570, Washington, DC, 20036, US

(21) Appl. No.: 12/578,448

(22) Filed: Oct. 13, 2009

(30) Foreign Application Priority Data
Aug. 13, 2009 (KR) 10-2009-0074780

(51) Int. Cl. F16H 57/02; F16D 3/84

(52) U.S. Cl. 74/606 R; 464/178

(57) ABSTRACT

Disclosed is an anti-vibration device of an input/output shaft for a manual transmission of a vehicle, capable of absorbing vibration of input/output shafts so that the input/output shafts are prevented from being bent. The anti-vibration device of the input/output shafts for a manual transmission having a first shaft receiving power of an engine and a second shaft transmitting power through a stage driving gear formed on the first shaft. The anti-vibration device includes a transmission housing having an installation space provided therein with the first and second shafts, and at least one anti-vibration unit provided in the transmission housing perpendicularly to an axial direction of the first and second shafts. The anti-vibration unit is a support wall integrated with the transmission housing to absorb vibration so that the first and second shafts are prevented from being bent in directions opposite to each other.

### BACKGROUND OF THE INVENTION

1. Field of the Invention

The present invention relates to an anti-vibration device of an input/output shaft for a manual transmission of a vehicle, and more particularly to an anti-vibration device of an input/output shaft for a manual transmission of a vehicle, capable of reducing vibration of the input/output shaft so that the input/output shaft is prevented from being bent when the vehicle drives at a high speed.

2. Description of the Prior Art

A transmission is installed between an engine and a differential gear to adjust the speed and the torque of the engine suitably for the driving state of a vehicle, so that power of the engine is delivered to a driving wheel. The transmission is classified into a manual transmission, an automatic transmission, and a continuously variable transmission according to the operating scheme thereof.

The manual transmission is handled in multiple stages and the handling of the manual transmission is difficult. However, the manual transmission has a simple structure and a low price, and the breakdown rate thereof is low, so that the manual transmission has been extensively used.

Examples of such a manual transmission have been disclosed in Korean Patent Application No. 10-2001-0007533 (filed on Feb. 15, 2001) and Korean Patent Registration No. 10-0597351 (issued on Jun. 29, 2006).

FIG. 1A is a sectional view showing the structure of the manual transmission according to the related art, and FIG. 1B is a view showing the operating state of the manual transmission shown in FIG. 1A.

As shown in FIG. 1A, the manual transmission includes a transmission housing 1, an input shaft 2 that rotates by receiving the power of an engine from a clutch and is provided with a main drive gear 2a, a main shaft 3 that rotates a final reduction system while rotating by receiving the power of the input shaft 2, and a counter shaft 4 that is spaced apart from the main shaft 3 in parallel to the main shaft 3 to deliver the power, which has been received from the main drive gear 2a, to a driven gear 3a of each stage arranged on the main shaft 3.

The main shaft 3 includes a synchronizer 3b to synchronize driven gears 3a to each other, and the counter shaft 4 includes driving gears 4a to drive the driven gears 3a and reversing gears 4b for a reversing operation.

As shown in FIG. 1A, each stage driving gear 4a, the reversing gear 4b, and the driven gear 3a are settled matching with a selected transmission level by means of a shifter gear mounted on a shifting shaft arranged in parallel to the main shaft 3 and the count shaft 4 as a user manipulates a shift lever.

As shown in FIG. 1B, in the conventional manual transmission, the main shaft 3 and the counter shaft 4 may be bent in directions away from each other by centrifugal force while vibrating (jittering) in high-speed rotation, so that the engagement of the driving gear 4a of each stage, the reversing gear 4b, and the driven gear 3a of each stage may be released.

Since the manual transmission adapted to a front-engine rear-wheel drive type vehicle provided at a front portion thereof with an engine and having a rear wheel driven by the power of the engine has a long length, as a rotational speed is increased, a gear ratio is significantly decreased.

In contrast, the main shaft 3 and the counter shaft 4 may be bent in directions approaching each other due to the vibration of the main shaft 3 and the counter shaft 4, so that each stage driving gear 4a, the reversing gear 4b, and each stage driven gear 3a may be excessively geared with each other. Accordingly, the gears may be damaged, so that the fatigue of the gears may be increased due to the excessive gearing.

As described above, when the main shaft 3 and the counter shaft 4 are bent due to vibration, a housing 1 of the conventional manual transmission may be cracked.

### SUMMARY OF THE INVENTION

Accordingly, the present invention has been made keeping in mind the above problems occurring in the prior art, and an object of the present invention is to provide an anti-vibration device of an input/output shaft for a manual transmission of a vehicle, capable of reducing vibration of the input/output shaft so that the input/output shaft is prevented from being bent.

To accomplish these objects, according to one aspect of the present invention, there is provided an anti-vibration device of an input/output shaft for a manual transmission of a vehicle, in which the manual transmission includes a first shaft that receives power of an engine to rotate and a second shaft that transmits power through a stage driving gear formed on the first shaft. The anti-vibration device includes a transmission housing that includes an installation space provided therein with the first and second shafts, and at least one anti-vibration unit provided in the transmission housing perpendicularly to an axial direction of the first and second shafts. The anti-vibration unit is a support wall integrated with the transmission housing to absorb vibration so that the first and second shafts are prevented from bent in directions opposite to each other.

According to another aspect of the present invention, there is provided an anti-vibration device of an input/output shaft for a manual transmission of a vehicle, in which the manual transmission includes a first shaft that receives power of an engine to rotate and a second shaft that transmits power through a stage driving gear formed on the first shaft. The anti-vibration device includes a transmission housing that includes an installation space provided therein with the first and second shafts, and at least one anti-vibration unit provided in the transmission housing perpendicularly to an axial direction of the first and second shafts. The anti-vibration unit includes a support plate coupled with the first and second shafts to absorb vibration so that the first and second shafts are bent in directions opposite to each other.

As described above, according to the embodiment, the vibration of input/output shafts is absorbed by using an anti-vibration unit including a support wall or a support plate integrated with a transmission housing, so that the input/output shafts can be prevented from being bent.

Accordingly, according to the present invention, gear engagement can be prevented from being released when the input/output shafts are bent in directions away from each other due to vibration of the input/output shafts.

In addition, according to the present invention, the gears are prevented being damaged because the input/output shafts are bent in directions approaching each other due to the vibration of the input/output shafts so that the gears are excessively engaged. Accordingly, the fatigue of the gears can be deceased.

Further, the transmission housing can be prevented from being cracked due to the bending of the input/output shafts caused by the vibration of the input/output shafts.

### BRIEF DESCRIPTION OF THE DRAWINGS

The above and other objects, features and other advantages of the present invention will be more clearly understood from the following detailed description when taken in conjunction with the accompanying drawings, in which:

FIG. 1A is a sectional view showing the structure of a manual transmission according to the related art;

FIG. 1B is a view showing the operating state of the manual transmission of FIG. 1A;

FIG. 2 is a perspective view showing an anti-vibration device of an input/output shaft for a manual transmission of a vehicle according to the preferred embodiment of the present invention;

FIG. 3 is an exploded perspective view of a counter shaft adapted to the anti-vibration device shown in FIG. 2;

FIGS. 4A to 4B are sectional perspective views showing a transmission housing of FIG. 2;

FIG. 5 is a view showing the assembly relation in an anti-vibration device of an input/output shaft for a manual transmission of a vehicle according to a preferred embodiment of the present invention;

FIG. 6 is a view showing the operating state of an anti-vibration device of an input/output shaft for a manual transmission of a vehicle according to a preferred embodiment of the present invention; and

FIG. 7 is a perspective view showing the structure of an anti-vibration device of an input/output shaft for a manual transmission of a vehicle according to another embodiment of the present invention.

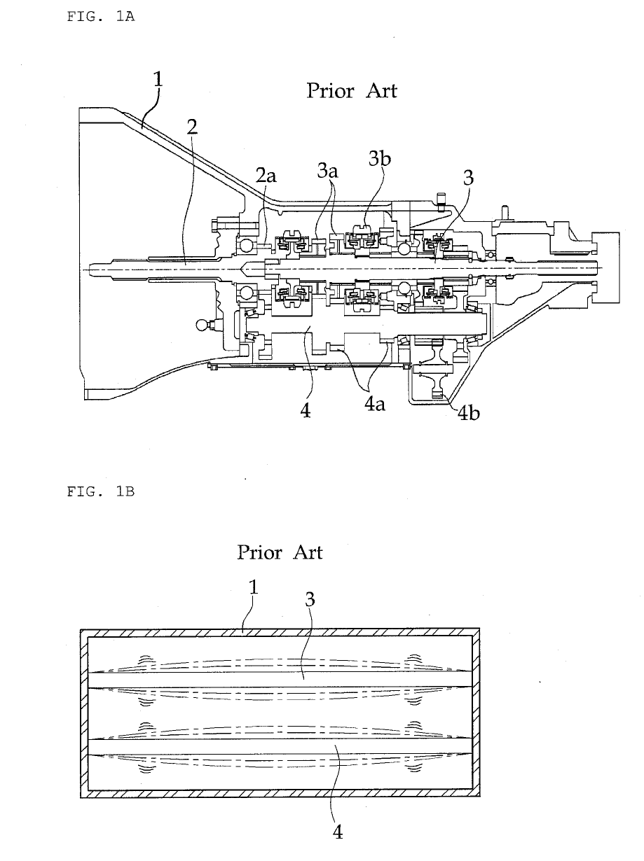

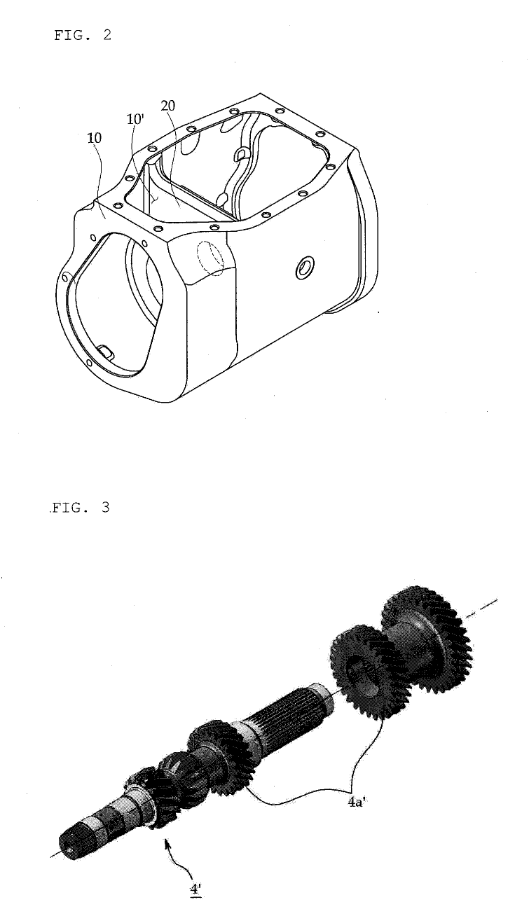

### DETAILED DESCRIPTION OF THE INVENTION

Hereinafter, an anti-vibration device of an input/output shaft for a manual transmission of a vehicle according to a preferred embodiment of the present invention will be described in detail with reference to accompanying drawings.

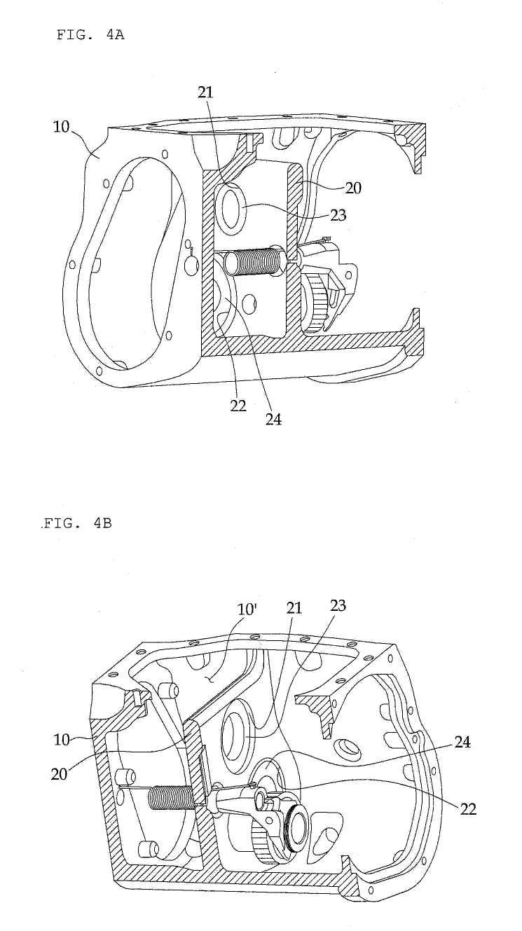

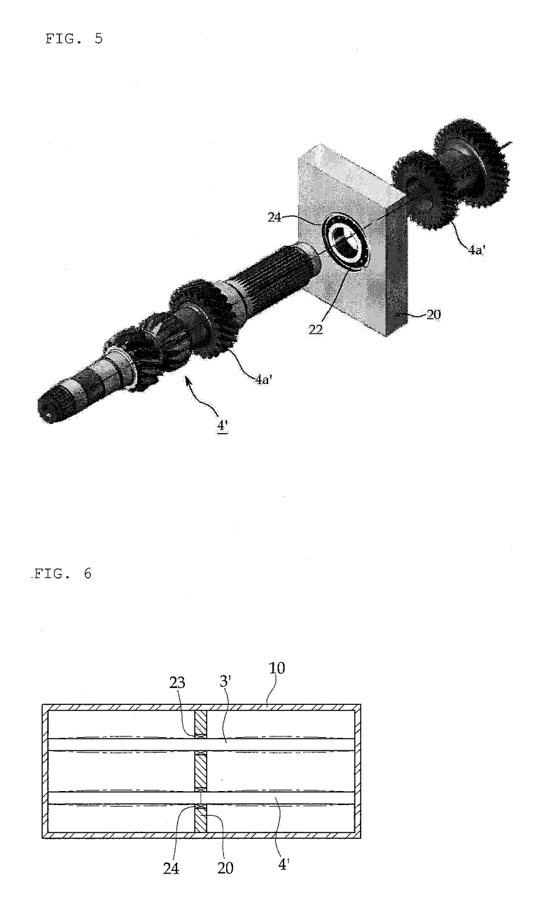

FIG. 2 is a perspective view showing the anti-vibration device of the input/output shaft for the manual transmission of the vehicle according to the preferred embodiment of the present invention, and FIG. 3 is an exploded perspective view of a counter shaft adapted to the anti-vibration device shown in FIG. 2. FIGS. 4A to 4B are sectional perspective views showing a transmission housing of the manual transmission.

Hereinafter, a manual transmission of a rear-wheel drive type vehicle will be described according to the present embodiment. However, the present invention can be adapted to a front-wheel drive type vehicle as well as the rear-wheel drive type vehicle.

In the following description, the same reference numerals are assigned to elements identical to those of the related art.

As shown in FIG. 2, an anti-vibration device of the input/output shaft for a manual transmission of a vehicle according to the present invention includes a transmission housing 10 and an anti-vibration unit 20 installed in the transmission housing 10 to absorb the vibration of a main shaft 3′ and a counter shaft 4′.

According to a preferred embodiment of the present invention, the main shaft 3′, the counter shaft 4′, and a shifting shaft may be coupled with each other at both sides of the anti-vibration unit 20.

For example, as shown in FIG. 3, different from the related art in which stage driving gears 4a′ are integrally provided, the counter shaft 4′ is provided at one side thereof with some stage driving gears 4a′ and provided at the other side thereof with remaining stage driving gears 4a′ that are detachably coupled with the counter shaft 4′.

Although not shown in FIG. 3, the main shaft 3′ is provided at one side thereof with some driven gears 3a and provided at the other side thereof with remaining driven gears 3a that are detachably coupled with the main shaft 3′.

The transmission housing 10 has a cylindrical shape and is provided therein with an installation space 10′ in which an input shaft 2, the main shaft 3′, and the counter shaft 4′ are installed.

The transmission housing 10 is provided therein with the anti-vibration unit 20.

As shown in FIGS. 4A and 4B, the anti-vibration unit 20 includes a support wall positioned at the substantially central portion of the transmission housing 10 and integrated with the transmission housing 10 perpendicularly to an axial direction of the main shaft 3′ and the counter shaft 4′. Although one support wall is shown in FIGS. 4A and 4B, two or more support walls may be formed. In this case, the support walls may be spaced apart from each other at various intervals.

First and second insertion holes 21 and 22 are formed through the support wall such that the main shaft 3′ and the counter shaft 4′ can pass through the first and second insertion holes 21 and 22.

First and second bearings 23 and 24 are disposed around the first and second insertion holes 21 and 22 to fit the main shaft 3′ and the counter shaft 4′ while smoothly rotating the main shaft 3′ and the counter shaft 4′.

Preferably, the first and second bearings 23 and 24 include a radial bearing to support the vertical load of the main shaft 3′ and the counter shaft 4′.

Preferably, the support wall includes aluminum alloy similarly to the transmission housing 10, and is insertion-molded to improve the strength thereof such that a peripheral portion of the first and second insertion holes 21 and 22 of the support wall can support the first and second bearings 23 and 24.

Hereinafter, the assembly relation in the anti-vibration unit 20 of the input/output shaft for the manual transmission of the vehicle having the above structure according to a preferred embodiment of the present invention will be described with reference FIGS. 4A, 4B, and 5.

FIG. 5 is a view showing the assembly relation in the anti-vibration unit 20 of the input/output shaft for the manual transmission of the vehicle structure according to a preferred embodiment of the present invention.

As shown in FIGS. 4A to 4B, the transmission housing 10 includes the installation space 10′ provided therein with the input shaft 2, the main shaft 3′, and the counter shaft 4′, and the support wall that is the anti-vibration unit 20 placed at the central portion of the installation space 10′ and integrated with the transmission housing 10.

In the above structure, the first and second bearings 23 and 24 are disposed around the first and second insertion holes 21 and 22.

As shown in FIG. 5, the main shaft 3′ and the counter shaft 4′ are inserted into the support wall from one side thereof.

Then, the driven gears 3a and the driving gears 4a′ that can be detachably coupled with the main shaft 3′ and the counter shaft 4′ are coupled with the support wall from the other side of the support wall.

Hereinafter, the operation of the anti-vibration unit 20 according to a preferred embodiment of the present invention will be described with reference to FIG. 6.

FIG. 6 is a view showing the operating state of the anti-vibration unit 20 according to a preferred embodiment of the present invention.

If a clutch is coupled with a flywheel of an engine, so that the power of the engine is delivered to the input shaft 2, the counter shaft 4′ receives the power of the engine by a main driver gear 2a of the input shaft 2 to rotate.

Next, the counter shaft 4′ transmits power to the stage driven gears 3a, which have been engaged with the stage driving gear 4a′ or a reversing gear 4b, through the stage driving gear 4a′ or a reversing gear 4b. Accordingly, the main shaft 3′ rotates at a rotational speed according to the power.

When the power is transmitted, the first and second bearings 23 and 24 coupled with the main shaft 3′ and the counter shaft 4′, respectively, fit the main shaft 3′ and the counter shaft 4′ into the first and second insertion holes 21 and 22. Simultaneously, the first and second bearings 23 and 24 smoothly rotate the main shaft 3′ and the counter shaft 4′ while stably supporting the weight and the load of the main shaft 3′ and the counter shaft 4′.

Particularly, when the input shaft 2, the main shaft 3′, and the counter shaft 4′ rotate at a high speed, since the first and second bearings 23 and 24 are fixed to the anti-vibration unit 20 (i.e., a support wall) integrated with the transmission housing 10, the first and second bearings 23 and 24 prevent the main shaft 3′ and the counter shaft 4′ from vibrating, so that the main shaft 3′ and the counter shaft 4′ can be prevented from being bent by centrifugal force.

Accordingly, it is possible to prevent the engagement of each stage driving gear 4a′ or the reversing gear 4b and each stage driven gear 3a from being released due to the bending of the main shaft 3′ and the counter shaft 4′ caused by the vibration of the main shaft 3′ and the counter shaft 4′ when the main shaft 3′ and the counter shaft 4′ rotate at a high speed.

In addition, it is possible to prevent the stage driving gear 4a′ or the reversing gear 4b and the stage driven gear 3a from being damaged due to the excessive engagement of the gears caused by the bending of the main shaft 3′ and the counter shaft 4′, so that the fatigue of the gears can be reduced.

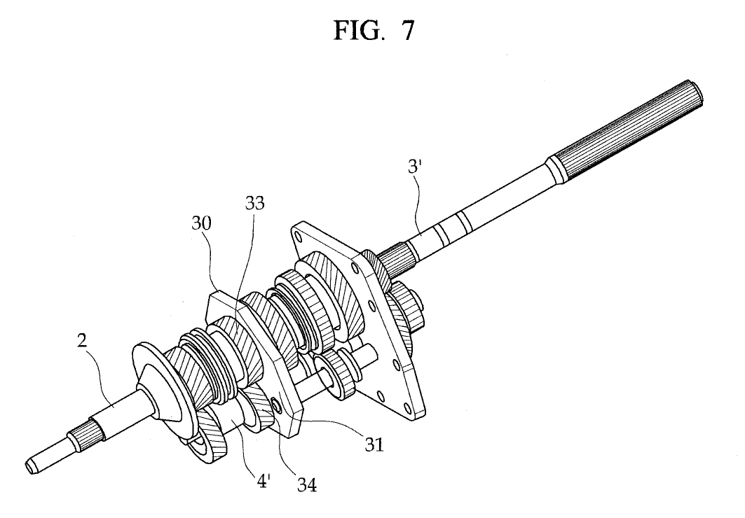

FIG. 7 is a perspective view showing the structure of an anti-vibration unit 30 of an input/output shaft for a manual transmission of a vehicle according to another embodiment of the present invention.

As shown in FIG. 7, according to the present invention, the anti-vibration unit 30 includes a support plate 31 supporting first and second bearings 33 and 34 coupled with a main shaft 3′and a counter shaft 4′.

The support plate 31 constantly maintains the distance between the main shaft 3′and the counter shaft 4′ to prevent the engagement of stage driving gears 4a′ and a reversing gear 4b, and stage driven gears 3a from being released.

As described above, when the anti-vibration unit 30 includes the support plate 31, the support plate 31 can be assembled with the first and second bearings 33 and 34 in the process of assembling the main shaft 3′ and the counter shaft 4′. Therefore, according to the present embodiment, the number of assembling processes can be reduced, and the assembly property can be improved as compared with the previous embodiment employing the support wall.

In addition, according to the previous embodiment, an existing design must be modified such that the driven gears 3a of the main shaft 3′ and the diving gears 4a′ of the counter shaft 4′, and the reversing gear 4b are installed between the transmission housing 1 and the support wall. However, according to the present embodiment, the support plate 31 can be easily installed by freely changing the shape and the location thereof without modifying existing main shaft 3 and counter shaft 4.

As described above, according to the present invention, the vibration of each shaft caused by high-speed rotation of the input/output shafts provided in the manual transmission is absorbed, thereby preventing the release of the engagement between a driving gear and a driven gear for each stage and preventing the gears from being damaged.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An anti-vibration device of an input/output shaft for a manual transmission of a vehicle, in which the manual transmission includes a first shaft that receives power of an engine to rotate and a second shaft that transmits power through a stage driving gear formed on the first shaft, the anti-vibration device comprising:
a transmission housing that includes an installation space provided therein with the first and second shafts; and
at least one anti-vibration unit provided in the transmission housing perpendicularly to an axial direction of the first and second shafts,
wherein the anti-vibration unit is a support wall integrated with the transmission housing to absorb vibration so that the first and second shafts are prevented from being bent in directions opposite to each other.

2. The anti-vibration device of claim 1, wherein the anti-vibration device includes:
first and second through holes, into which the first and second shafts are inserted; and
first and second bearings coupled with the first and second shafts and fixed into the first and second through holes.

3. The anti-vibration device of claim 2, wherein the first and second shafts are provided at one side thereof with some stage driving gears and some stage driven gears, respectively, and provided at an opposite side thereof with remaining stage driving gears and remaining stage driven gears which are detachably coupled with the first and second shafts.

4. An anti-vibration device of an input/output shaft for a manual transmission of a vehicle, in which the manual transmission includes a first shaft that receives power of an engine to rotate and a second shaft that transmits power through a stage driving gear formed on the first shaft, the anti-vibration device comprising:
a transmission housing that includes an installation space provided therein with the first and second shafts; and
at least one anti-vibration unit provided in the transmission housing perpendicularly to an axial direction of the first and second shafts,
wherein the anti-vibration unit includes a support plate coupled with the first and second shafts to absorb vibration so that the first and second shafts are prevented from being bent in directions opposite to each other.

5. The anti-vibration device of claim 4, wherein the anti-vibration device includes:
first and second through holes, into which the first and second shafts are inserted; and
first and second bearings coupled with the first and second shafts and fixed into the first and second through holes.

6. The anti-vibration device of claim 5, wherein the first and second shafts are provided at one side thereof with some stage driving gears and some stage driven gears, respectively, and provided at an opposite side thereof with remaining stage driving gears and remaining stage driven gears which are detachably coupled with the first and second shafts.
